(19) United States
(12) Patent Application Publication
(10) Pub. No.: US 2015/0114104 A1
(43) Pub. Date: Apr. 30, 2015

(54) Spooled Tank Level Sensor System and Method

(71) Applicant: Maumus F. CLAVERIE, III, San Antonio, TX (US)

(72) Inventor: Maumus F. CLAVERIE, III, San Antonio, TX (US)

(21) Appl. No.: 14/315,265

(22) Filed: Jun. 25, 2014

Related U.S. Application Data
(60) Provisional application No. 61/839,289, filed on Jun. 25, 2013.

(51) Int. Cl. G01F 23/284

(52) U.S. Cl. CPC G01F 23/284
USPC 73/290 V

(57) ABSTRACT

A spool system for the deployment of a fluid level sensor with a flexible element. The system may be used with a variety of different sensors that may be deployed into a fluid containment tank from the spool. The sensor deployment system may be installed on closed or open tanks and is operable with tanks of various construction materials. The system is operable with tanks containing a wide range of fluids (water, oil, etc.) although it finds preferred application with remotely located oil field storage tanks The system includes a flexible sensor line positioned on a spool within a sealed enclosure. The spool may be rotated manually through the use of an external hand crank, or may be operated automatically. The spool enclosure is in open communication through a top collar of the tank (for closed tanks) for deployment of the flexible sensor. For tanks that are pressurized the spool enclosure serves to maintain the tank pressure. For open tanks the system may be mounted on a bracket on the side wall of the tank. Adjacent the spool enclosure is a sealed electronics enclosure in signal communication with the flexible sensor on the spool through slip ring contacts and signal wire conductors. The electronics of the system may preferably include a power input connector and RF (or other electromagnetic wave) transmitters, receivers, and antennas.

### CROSS REFERENCES TO RELATED APPLICATIONS

This application claims the benefit under Title 35 United States Code §119(e) of U.S. Provisional Patent Application Ser. No. 61/839,289, filed: Jun. 25, 2013, the full disclosure of which is incorporated herein by reference.

### BACKGROUND OF THE INVENTION

1. Field of the Invention

The present invention relates generally to sensor systems and methods for measuring the level of a liquid within a tank. The present invention relates more specifically to a spooled sensor system, easily deployed within tanks of varying sizes, and operable to remotely monitor the level of liquid in the tank.

2. Description of the Related Art

Many efforts have been made in the past to provide systems and methods for monitoring the level of liquids within tanks. Many such systems are implemented within the petroleum industry and are used in association with oil field tanks and the like located at well sites, typically in remote areas. One of the most important considerations in the oil and gas industry is the process of monitoring well production. Because wells are often located in remote areas, it is difficult to monitor production as it is pumped into tanks from the wells and thereafter pumped out of tanks into pipe lines or, more frequently, transport tanker trucks. It can be time consuming and inefficient to manually monitor liquid levels within the field tanks, especially with the frequency that is often required with modern production schedules. Automated tank level monitoring systems have therefore been developed.

While there are many automated tank level monitoring systems currently in use, most suffer from the limitation that they must be specifically manufactured for the particular tank on which they are installed. Because oil field tanks come in a wide range of shapes, sizes, and configurations, it is difficult to make one, or even a few, standard sized tank level monitoring systems. This is especially true with regard to the structure and size of the sensor element disposed within the tank. It would be desirable, therefore, to have a tank level sensor system that could be easily installed on any of a wide range of tank configurations without the need for significant customization in the manufacturing process or in the installation process. It would be desirable if the size (length) and configuration of the sensor system could be standardized at manufacture and any necessary adjustments to the size could be easily made with a “plug and play” installation.

Some efforts have been made to introduce flexible sensor systems into the industry whereby a long sensor structure may be introduced into a tank without the need for initially structuring rigid columns, tubes, pipes, and other vertical frameworks, typically used in conjunction with tank level monitoring systems. Even such flexible sensor systems, however, must be adapted (primarily by customizing their length) for a particular installation and often require significant time and labor to install, test, and/or calibrate before being operable.

It would be desirable to have a flexible sensor system that could be easily installed on any of a large number of different sized tanks with different tank configurations and without the need for a rigid sensor column or standpipe.

### SUMMARY OF THE INVENTION

In fulfillment of the above and other objectives, the present invention provides a spool or reel system for the deployment of a flexible fluid level sensor. The present invention provides a system for use with a number of different types of flexible fluid level sensors, each of which may be deployed into a fluid containment tank from the spool or reel. The sensor deployment system may be installed on closed or open tanks and is operable with steel tanks, fiberglass tanks, and tanks made of polymer materials. The system is operable with tanks containing a wide range of fluids (water, oil, etc.) although it finds its preferred application with remotely located oil field storage tanks. The system includes a flexible sensor positioned on a spool within a spark proof or explosion proof enclosure. The spool may be rotated manually through the use of an external hand crank, or in alternate embodiments may be operated automatically. The spool enclosure is in open communication with and through the tank collar of the tank (for closed tanks) for deployment of the flexible sensor. For tanks that are pressurized the spool enclosure serves to maintain the tank pressure. For open tanks the system may be mounted on a bracket on the side wall of the tank. Adjacent the spool enclosure is a separate and fully sealed electronics enclosure in signal communication with the flexible sensor on the spool through slip ring contacts and signal wire conductors. The electronics of the system may preferably include a power input connector and RF (or other electromagnetic wave) transmitters, receivers, and antennas.

Each type of flexible sensor system will typically include a tension weight that is first deployed through the tank collar to direct the flexible sensor in a generally vertical line to the bottom of the tank (more specifically, to just off the bottom of the tank). Some sensor embodiments utilize one or more floats surrounding the flexible sensor with magnets that trigger elements within the flexible sensor to detect the level of oil or water on the vertical sensor column. Other spooled flexible sensor systems anticipated by the structures of the present invention may operate utilizing terminal end sensors or long wire or tube wave guide sensor methodologies. The common characteristic of each of the sensor systems described in the present invention is the manner in which the flexible sensor may be deployed from the spool to any specific length required by the particular tank installation and may be immediately operable at that length by way of the electronics, programming, and connections to the flexible sensor as structured.

### BRIEF DESCRIPTION OF THE DRAWINGS

FIG. 1A is a partial schematic perspective view of a first implementation of the sensor system of the present invention utilized in conjunction with a sensor line made up of magnetically sensitive sensor elements.

FIG. 1B is a detailed cross-section view of a typical flexible printed circuit board (PCB) sensor device with discrete magnetically sensitive sensor elements.

FIG. 1C is a top plan view of an alternate configuration of the sensor shown in FIG. 1A with a series of rigid printed circuit board (PCB) elements connected through flexible conductors, again utilizing discrete magnetically sensitive sensor elements.

FIG. 2A is a partial schematic perspective view of a second implementation of the sensor system of the present invention, utilized in conjunction with a differential pressure sensor system.

FIG. 2B is a detailed cross-sectional view of a typical sensor line structure for the system shown in FIG. 2A.

FIG. 3A is a partial schematic perspective view of a third implementation of the sensor system of the present invention, utilized in conjunction with a guided wave radar sensor system.

FIG. 3B is a detailed cross-sectional view of a typical sensor line structure for the system shown in FIG. 3A.

FIG. 4A is a partial schematic perspective view of a fourth implementation of the sensor system of the present invention, utilized in conjunction with a magnetostrictive wire (wave guide) sensor system using time domain reflectometry (TDR).

FIG. 4B is a detailed cross-sectional view of a typical sensor line structure for the system shown in FIG. 4A.

FIG. 5A is a partial schematic perspective view of a fifth implementation of the sensor system of the present invention, utilized in conjunction with a wave form tube (wave guide) sensor system using time domain reflectometry (TDR) with mechanical or electromagnetic waves.

FIG. 5B is a detailed cross-sectional view of a typical sensor line structure for the system shown in FIG. 5A.

FIG. 6A is a partial schematic perspective view of a sixth implementation of the sensor system of the present invention, utilized in conjunction with a capacitance sensor system.

FIG. 6B is a detailed cross-sectional view of a typical sensor line structure for the system, shown in FIG. 6A.

FIG. 7 is a partially schematic perspective view of an example of one type of power system, operable in remote locations, for use in conjunction with the systems of the present invention.

FIG. 8 is a perspective view of an installation of the system of the present invention on a typical oil field tank structure.

FIG. 9A is an elevational side view of the spool enclosure and electronics enclosure components of the system of the present invention.

FIG. 9B is a partial cross-sectional end view of the spool enclosure component of the system of the present invention.

FIGS. 10A & 10B are detailed front and side views of the embodiment of the present invention shown generally in FIG. 1C.

FIG. 11 is an electronic schematic block diagram showing the functional operation of the daisy chain arrangement of the sensor elements of the system of the present invention shown generally in FIG. 1C.

FIG. 12 is a schematic diagram showing an overview of a length of flexible sensor strip extending into a tank with the floating magnets positioned adjacent the sensor strip.

FIGS. 13A-13C are data plots showing the sensor readings for the example sensor and floating magnet arrangement shown in FIG. 12. FIG. 13A plots the raw data from the sensors, FIG. 13B provides a curve fitting analysis of the raw data, and FIG. 13C provides the reduction of the curve fitting analysis to a measured level value for each of the two floating magnets.

FIG. 14 is an open side view of a further alternate embodiment of the spool enclosure assembly of the present invention shown mounted and secured with a coupling to the liquid tank.

### DETAILED DESCRIPTION OF THE PREFERRED EMBODIMENTS

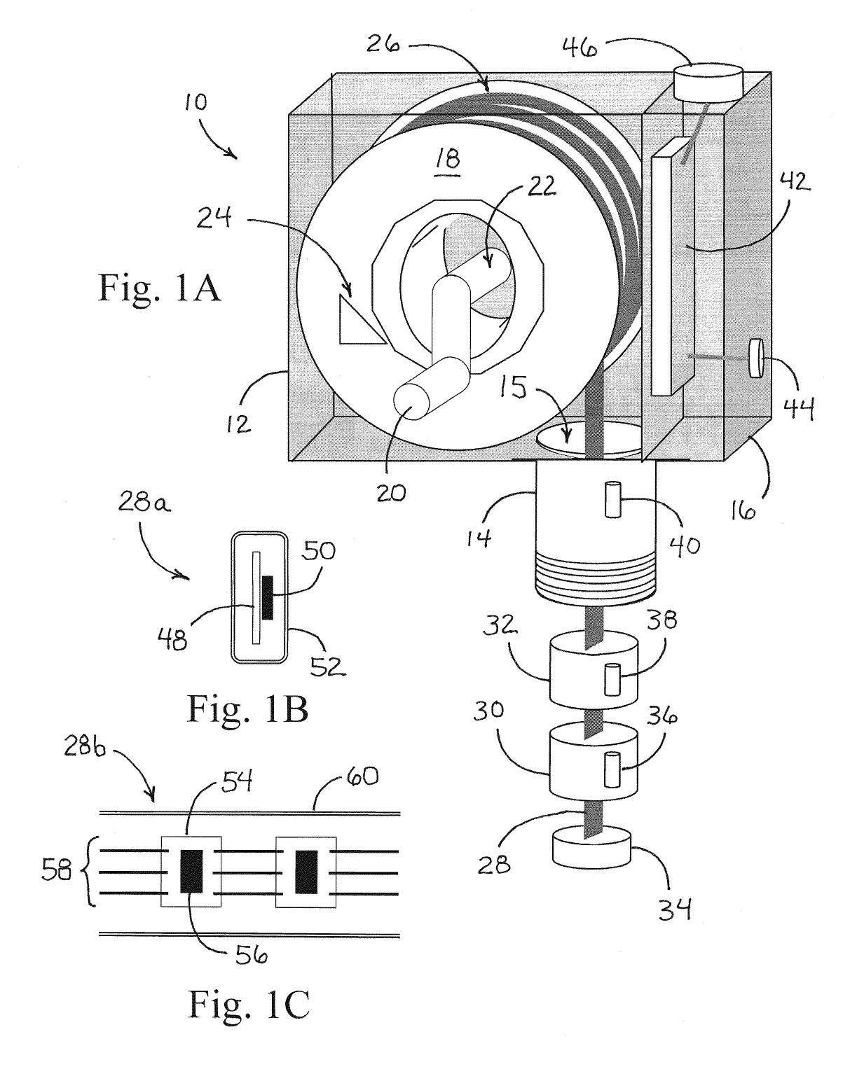

Reference is made to FIGS. 1A-1C for a description of a first implementation of the system of the present invention in conjunction with a flexible sensor element comprising magnetically sensitive sensor elements, such as Hall Effect sensors or reed switches. Sensor system 10 generally includes spark proof or explosion proof enclosure 12 connected to and open through aperture 15 to tank collar 14. This spool side of the enclosure is in flow communication with, and where applicable, maintains a seal with the tank environment. Where the installation is on an open tank the spool enclosure is positioned on a bracket on the side wall (or a frame structure) of the tank and is, of course, open to the atmosphere through the lower port aperture 15. The electronics of the system are contained within a separate enclosure 16 positioned next to the spool enclosure 12. Signal connections between the two enclosures are described in more detail below.

Within spool enclosure 12 is positioned spool 18, operable by external hand crank 20 in the preferred embodiment. Those skilled in the art will recognize that operation of spool 18 may be accomplished by other means apart from the manual operation of hand crank 20. As reduced power consumption is one of the goals of the present invention, the preferred embodiment utilizes an easily deployed system that involves turning of hand crank 20 which rotates spool 18 on axle 22. Ratcheting latch 24 allows the spool to be fixed in a rotated position after deployment of the flexible sensor element, depending on the specific application at hand.

A quantity of flexible sensor 26 is reeled onto spool 18 in the manner shown. Preference is to have a single coil stack of sensor element on the spool. The end of flexible sensor 28 may be drawn out from spool 18 in the deployment process. With the sensor system shown in FIG. 1A (i.e., utilizing discrete magnetically sensitive sensor elements), a number of floats are positioned around flexible sensor element end 28 in a manner that allows the floats to move up and down the vertically oriented length of sensor element and thereby function as the fluid level measuring device. In the preferred embodiment, these floats include water float 30 with incorporated location magnet 36 having a specific gravity in the range of 0.94-0.99. As water float 30 moves up and down sensor element 28, magnet 36 triggers components within the sensor in a manner that is detectable by the electronics of the system outside of the tank. Above water float 30 is oil float 32 which incorporates location magnet 38 and should have a specific gravity of 0.60 or less. In addition, tank collar 14 incorporates location magnet 40 as a manner of referencing the deployment and position of the sensor system within the tank.

The electronics enclosure 16 includes a printed circuit board (PCB) with sensor control, event logic electronics, satellite modem electronics, mesh radio electronics, and the necessary power and signal connections. Printed circuit board 42 receives power from a short-pin safe power in connector 44. Outside communication with the system of the present invention is accomplished through a number of communications protocols by way of antenna radome 46.

FIGS. 1B & 1C provide additional detail on two different types of flexible sensor systems utilizing magnetically sensitive sensor elements in conjunction with the embodiment shown in FIG. 1A. FIG. 1B is a cross-sectional view of a first type of flexible sensor 28a that comprises a flexible printed circuit board 48 positioned with a plurality of magnetically sensitive sensor elements 50. This combination of sensor devices and flexible PCB is shown surrounded by a flexible sleeve 52.

FIG. 1C shows an alternate embodiment 28b of the sensor system shown in FIG. 1A wherein the flexible PCB is replaced by multiple rigid PCB sections 54, each with a discrete magnetically sensitive sensor element 56 interconnected with flexible conductor paths 58 (either discrete wires or small lengths of flexible circuit elements). This combination is again surrounded by a flexible sleeve 60. In place of a flexible sleeve shown and described, each of the embodiments shown in FIGS. 1A-1C may alternately be structured with coated or encapsulated components.

In general, the operation of the systems shown in FIG. 1A involves positioning and placement of the enclosures onto the tank collar with the end of the spooled flexible sensor line directed through the tank collar into the tank. Once fixed to the tank collar with a sealed connection, the user rotates the external handle which turns the spool of sensor line and deploys the end of the sensor element into the tank according to the length required by the specific tank size and configuration. A locking latch system described above then fixes the spool at the desired deployment length for operation of the sensor system.

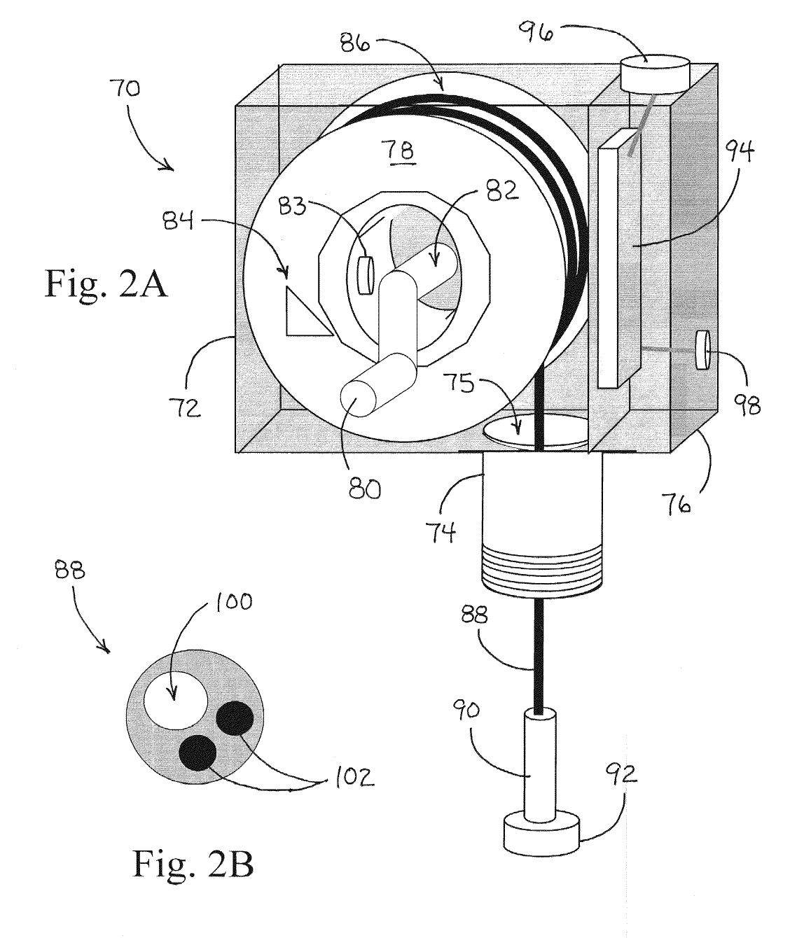

Reference is next made to FIGS. 2A & 2B for a description of a second embodiment of the system of the present invention implemented in conjunction with a differential pressure sensor type tank level measurement device. Most of the components of this system are the same or similar to those shown in FIG. 1A and for system 70 include, explosion proof enclosure 72 as the spool enclosure attached to tank collar 74 as shown. Sensor passage into the tank is provided by way of opening 75 in tank collar 74. Electronics are once again configured separately in the electronics enclosure 76. Spool 78 retains a quantity of sensor element line 86 and may be turned by external handle 80 which rotates spool axle 82. With this type of pressure based sensor system, vent 83 must be positioned within spool 78 at the terminal end of sensor element line 86.

Deployed sensor element line 88 terminates in a differential pressure sensor 90 that incorporates a diaphragm capable of measuring, by way of its displacement, the difference in pressure associated with the quantity (depth) of fluid above the sensor. Electronic components, including circuit board 94, power in connector 98, and communications antenna 96 are each similar to those described above in conjunction with FIG. 1A. The tank collar in each of the preferred embodiments of the present invention will preferably incorporate defouling brushes to help prevent degradation of the sensor line as it is deployed. In the system shown in FIG. 2A, a spacer 92 provided at the base of the sensor helps to prevent clogs from forming in the differential pressure sensor component 90. FIG. 2B is a cross-sectional view of sensor element line 88 showing vent tube 100 and wire leads 102 that provide power and signal communication to and from differential pressure sensor 90.

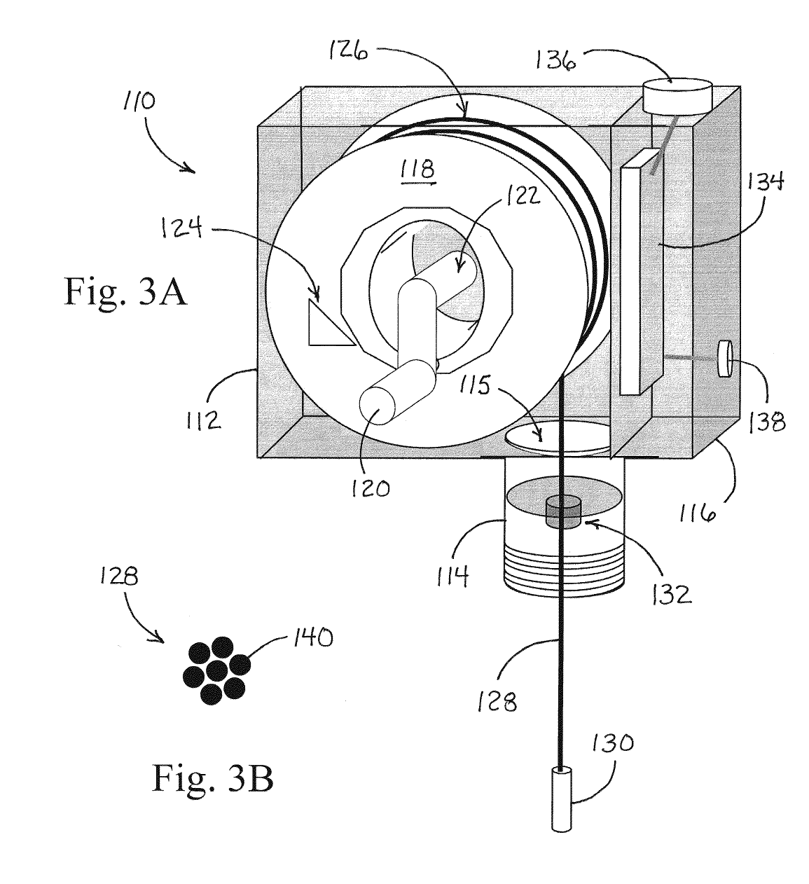

Reference is next made to FIGS. 3A & 3B which provide a third implementation of the spooled sensor system of the present invention in conjunction with a guided wave radar sensor platform and method. System 110 again includes spark proof or explosion proof enclosure 112 positioned on tank collar 114 in flow communication with the tank by way of aperture opening 115. Electronics are positioned within separate electronics enclosure 116. Spool 118 is again rotated by external handle 120 connected to spool axle 122. Locking latch 124 provides a manner of fixing the spool after deployment.

A quantity of reeled sensor element line 126 is positioned on spool 118. Sensor line 128 is deployed from spool 118 with the tank end incorporating tension weight 130. In this type of sensor system, tank collar 114 incorporates not only defouling brushes, but a grounding wall and radar launch point 132. Necessary electrical connections (not shown) are made between the radar launch point and the electronics of the system. The overall control components are once again included within electronics enclosure 116 which includes circuit board 134, receives power in through connector 138, and transmits and receives signals through antenna 136.

FIG. 3B shows in cross-sectional detail that sensor line 128 in this embodiment may be a simple length of stranded steel cable 140 that acts as a wave guide for a radio frequency (RF) pulse directed down and reflected back through the cable 140.

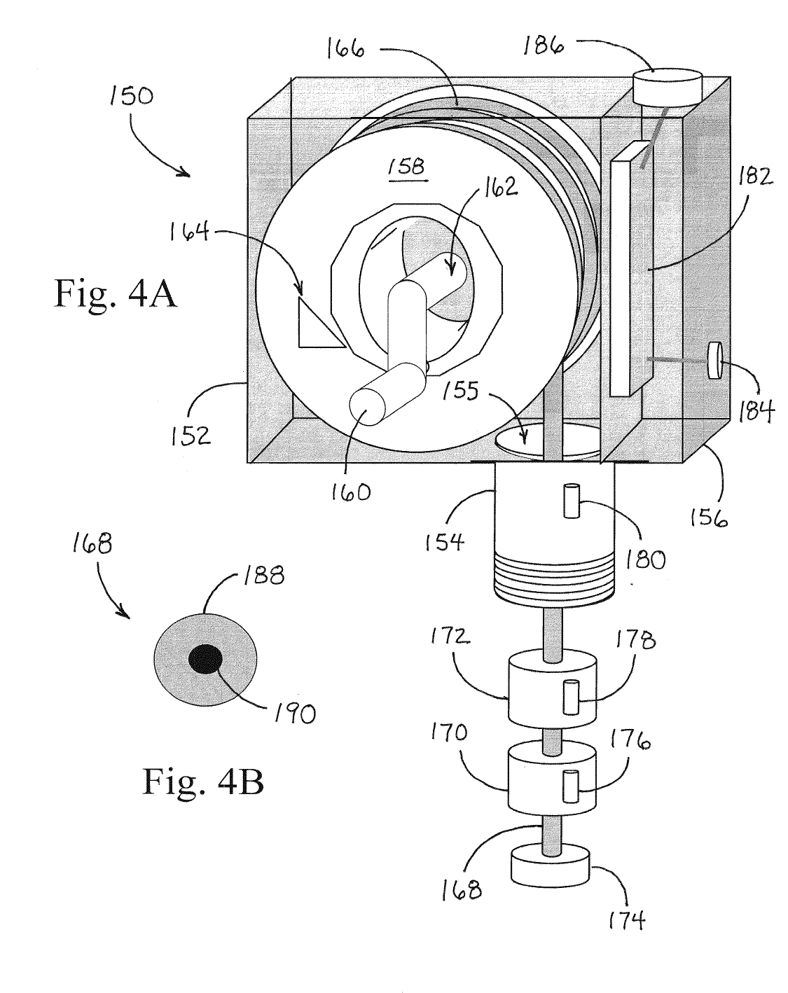

Reference is next made to FIGS. 4A & 4B for a description of a further alternate embodiment of the system and method of the present invention utilizing a magnetostrictive wire based sensor system. This embodiment is structured and is operable in a manner very similar to the embodiment shown in FIG. 1A which, once again, relies on the use of magnets contained within floats to identify the levels of various liquids within the tank. System 150 is configured with explosion proof enclosure 152, again attached to tank collar 154, that provides open communication there through into the tank by way of aperture 155. Electronics enclosure 156 is positioned next to spool enclosure 152.

Reel 158 contains a length of sensor line 166 which again is deployed into the tank as sensor line end 168, weighted with tension weight 174 as shown. Water float 170 contains location magnet 176 and oil float 172 contains location magnet 178. Again, the preferred embodiment also incorporates a location magnet 180 positioned in tank collar 154. The electronics of the system once again are incorporated onto circuit board 182 positioned within electronics enclosure 156. Power in connector 184 connects an external power source and antenna 186 allows for two-way communication with the remote office tank level monitoring system. FIG. 4B is a detailed cross-sectional view of a typical magnetostrictive wire sensor system that incorporates a central element 190 comprising a magnetostrictive alloy surrounded by a non-interactive shield or conduit structure 188.

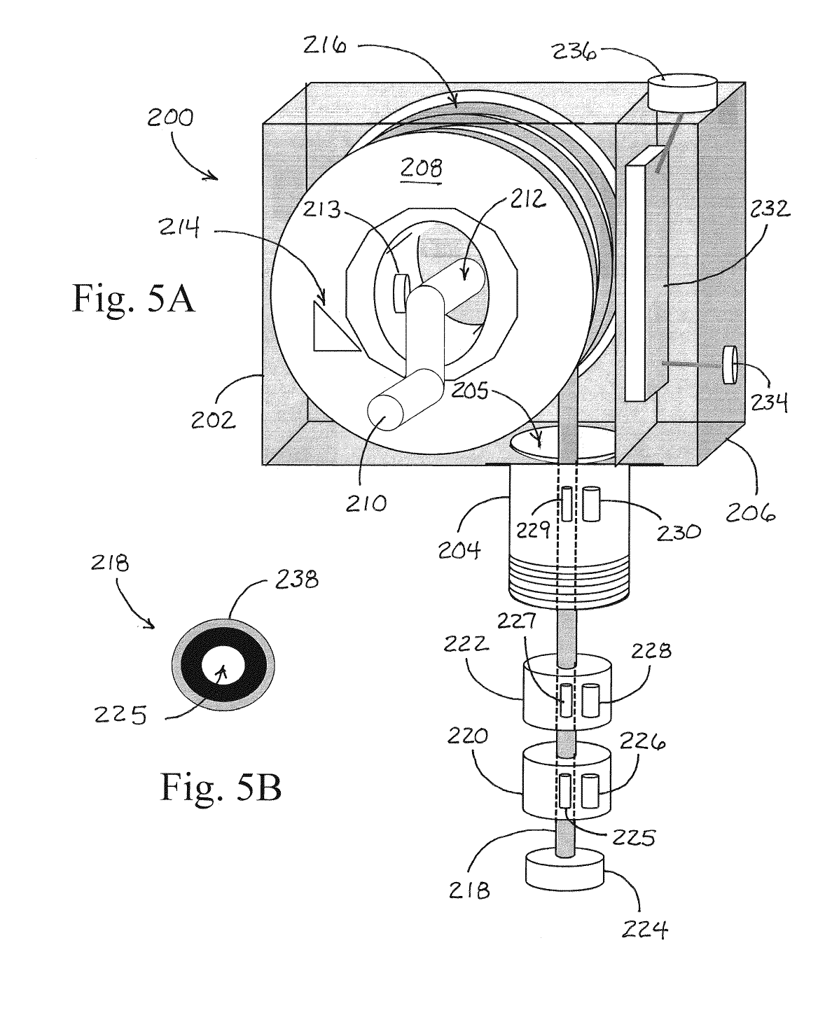

Reference is next made to FIGS. 5A & 5B for a further alternate embodiment of the system of the present invention implemented in conjunction with a wave guide tube type sensor system operable in conjunction with the transmission (and reflection) of a wave form through air or a material, measuring distance by known time domain reflectometry (TDR) techniques. System 200 again provides spool enclosure 202 attached to tank collar 204 providing opening 205 into the tank. Spool 208 maintains a quantity of wave guide tube 216 and may be deployed by rotation of handle 210 turning spool axle 212 as described above. Locking latch 214 fixes the spool in position after deployment.

The tank end of wave guide tube 218 is again deployed using tension weight 224. Water float 220 incorporates magnet 226 and is magnetically coupled to float marker 225 positioned on the inside of wave guide tube 218. In a similar manner, oil float 222 incorporates magnet 228 magnetically coupled to float marker 227. Tank collar 204 likewise incorporates location magnet 230 magnetically coupled to marker 229. Implementation of the wave guide tube sensor system of the present invention comprises operation of transducer 213 at the spooled end of sensor tube 216 which directs a wave form pulse down the sensor wave guide to encounter each of the markers 225, 227 & 229. The reflected waves are then detected and measured and the level of each marker identified as well as a reflection from to lower end of the wave guide (typically positioned just above the floor of the tank).

FIG. 5B provides a detailed view of a typical cross-section of sensor tube 218 comprising a length of flexible tubing that carries the wave forms down the wave guide sensor tube and the reflected wave forms up from the internal markers that are magnetically coupled to the float magnets and the tank collar magnet. In FIG. 5B marker 225 is shown positioned within the sensor tube surrounded by tubing wall 238.

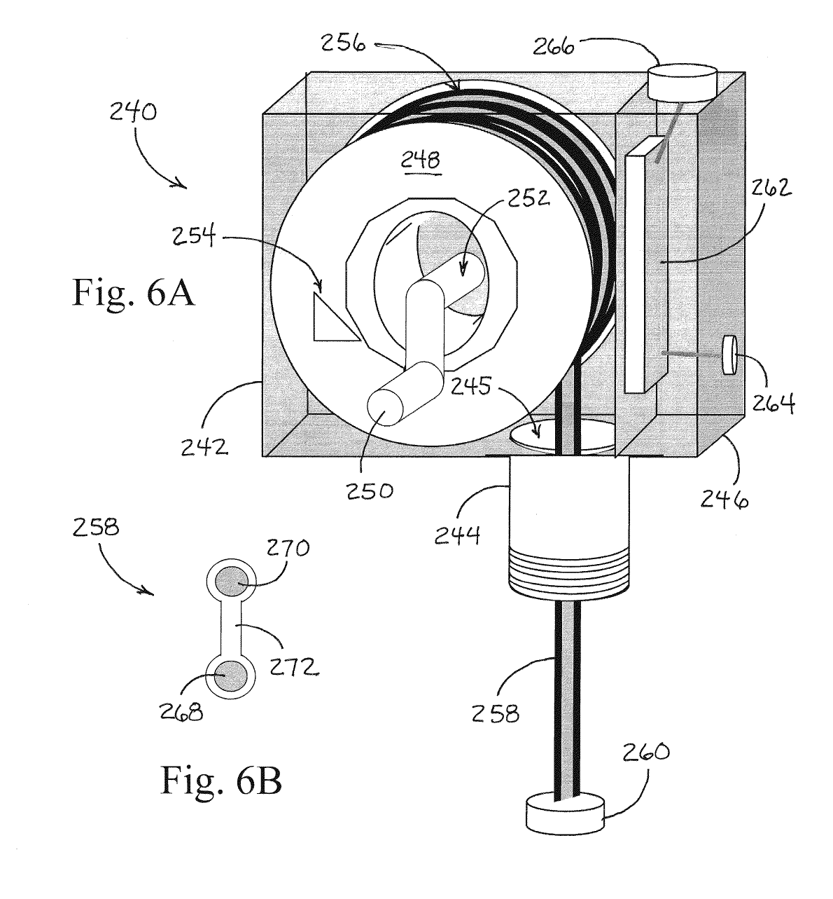

Reference is next made to FIGS. 6A & 6B for a further alternate implementation of the sensor system of the present invention in conjunction with a capacitance sensor based operation. System 240 again comprises spool enclosure 242 positioned next to electronic enclosure 246. Spool enclosure 242 is connected to tank collar 244 and provides opening 245 into the tank. Spool 248 is again configured with a reeled length of sensor line 256 and is operable by means of external handle 250 which turns spool axle 252 and rotates spool 248. Locking latch 254 fixes spool 248 into place after deployment.

Capacitance sensor line 258 terminates in the tank with tension weight 260. Operation of the system, seen best with the cross-sectional view of FIG. 6B, comprises a measurement of changes in the capacitance across a dielectric material 272 between two conductors 268 & 270. The presence of a liquid outside and surrounding the dielectric 272 changes the capacitance in a manner that is measurable from the end of the sensor line. Once again, the electronics that serve to measure these changes are positioned on circuit board 262 within electronics enclosure 246. Power input 264 and communications antenna 266 are structured in a manner similar to the systems described above.

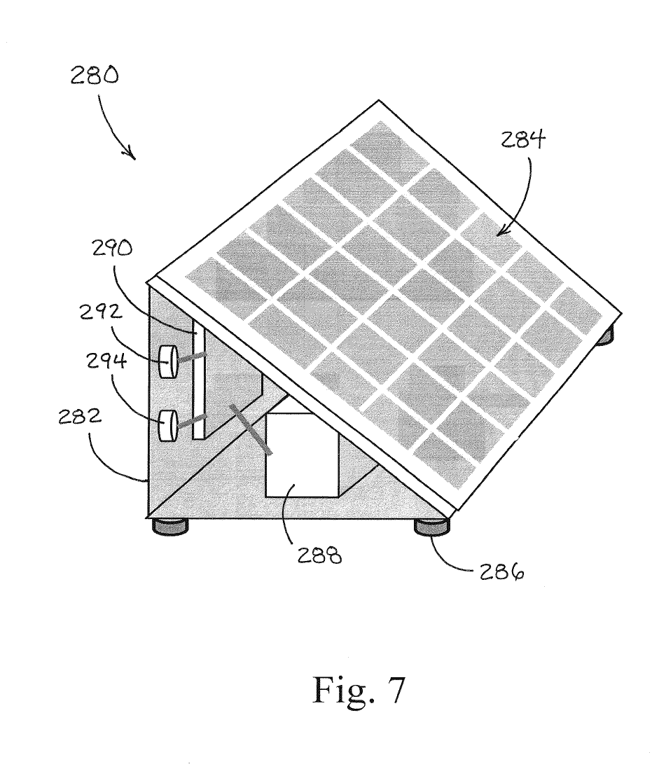

Reference is next made to FIG. 7 which provides one example of a suitable source of power for operation of the sensor system, typically at a remote location in an oil field. Power system 280 primarily comprises solar panel 284 generally positioned at an approximate 45° angle and optimally oriented based on the geographic location of the system's deployment. The typical suitable solar panel would provide 10-20 watts of power that charges a 12 volt battery system 288 operable in the range of 3-20 Amp hours. Electronic circuit board 290 provides the necessary charging circuitry, monitors battery health and battery strength, and likewise incorporates a short pin safety input/output connector 292. This input/output connector provides not only connection for power to the system, but also may include signal communication to relay power system health data to the communications circuitry of the sensor system. In addition, power and signal data connector 294 is provided to connect power system 280 to additional or auxiliary power systems. Where power is available at the site of the tank (typically in the form of 110 VAC or 220 VAC) an AC to DC convertor with a voltage regulator (not shown) may be used in place of the solar panel/rechargeable battery system shown.

Power system 280 is structured on and within enclosure frame 282 which is preferably fixed with magnetic feet 286 so as to be attached and secured to the top of the typical steel oil field tank in a position adjacent to the sensor system of the present invention. Tanks constructed of non-magnetic materials would require steel plates or the like be adhered to the top of the tank before the power system 280 is installed. Preferably, the overall enclosure frame 282 of power system 280 is itself an explosion proof enclosure as it comprises electrical power generating components in close proximity to petroleum storage tanks.

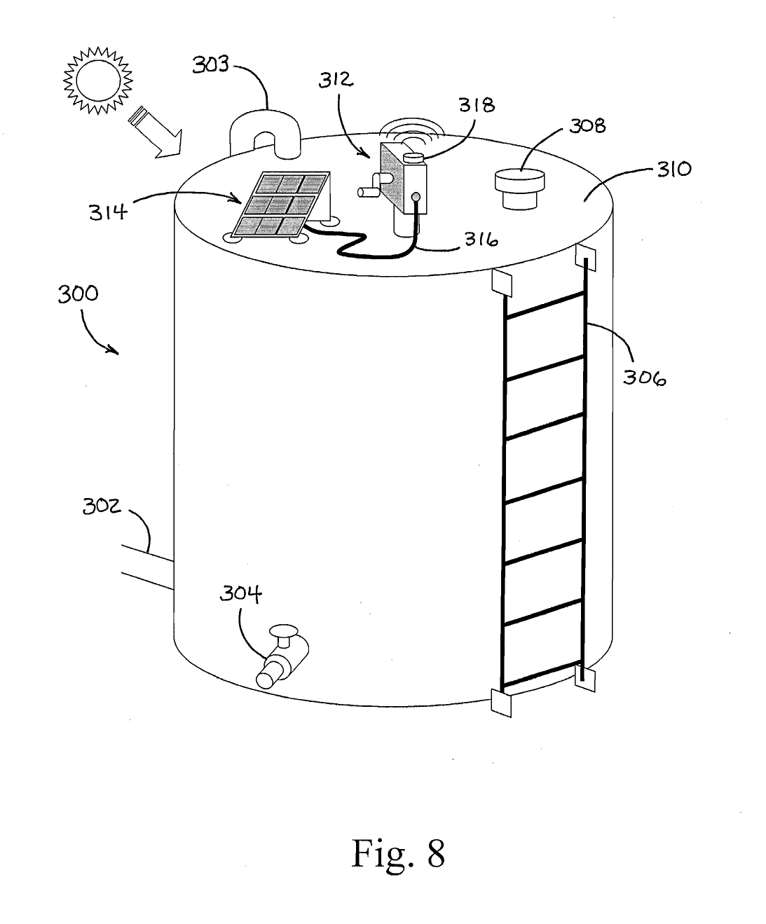

Reference is next made to FIG. 8 which provides an overview of an installation of a typical system of the present invention on an oil field tank. Tank structure 300 in this case is provided with a clean out line 302 as well as supply line 303, typically from an operational production well. Load line 304 may be utilized to draw product (the “sale” point) from the tank either by a pipe line or more commonly by tanker truck transport. Ladder 306 is shown as typically positioned on tank 300 allowing user access to the various components positioned on domed top platform 310 of tank 300. Such installations typically include a thief hatch 308 as well as other vent components normally associated with such tank structures.

In the example installation shown in FIG. 8, the tank collar is positioned on the tank through domed top platform and has been fixed with sensor system 312. Power system 314 is connected to sensor system 312 by way of electrical and signal line connection 316. Antenna 318 is now positioned for appropriate RF (or other EM wave) signal (terrestrial and/or satellite) communication.

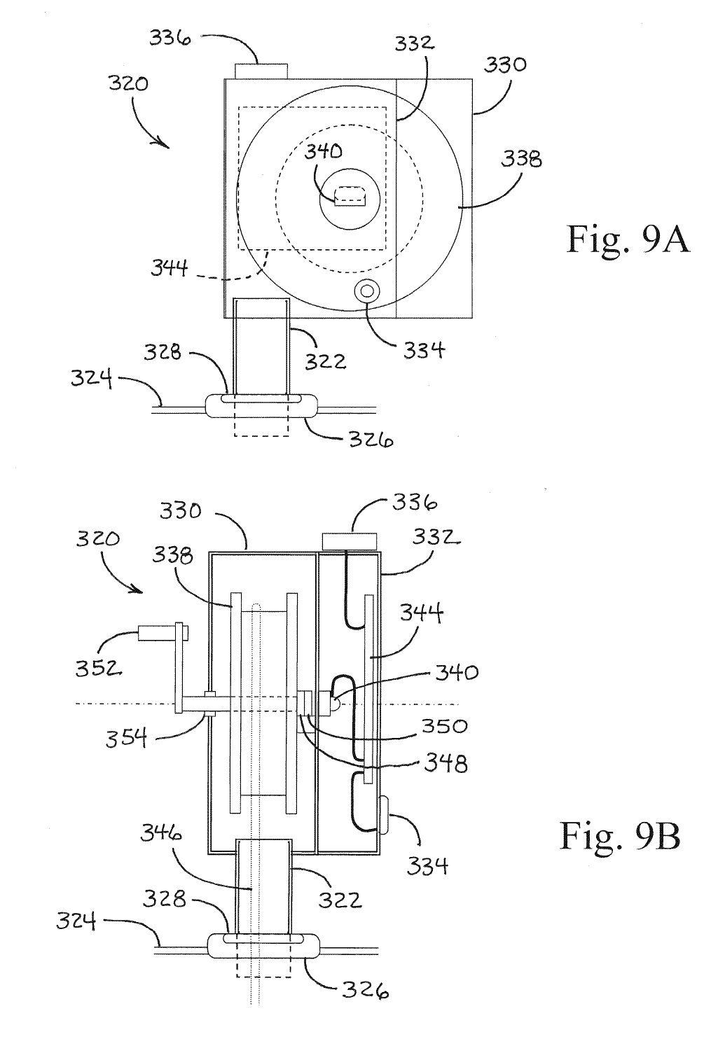

Reference is next made to FIGS. 9A & 9B for a more detailed description of the housing associated with the spooled flexible sensor system 320. As indicated above, the spooled flexible sensor housing 330 should be spark proof or explosion proof and should be sized to contain the maximum length of the sensor line 346 required by the full range of tanks to which it might be installed. The housing 330 should have a seal rating of IP 67. The housing will, as described above, incorporate a handle 352 that extends externally to the housing 330 for raising and lowering the flexible sensor line 346. The handle 352 may be locked in place with an indexed, spring loaded, latching mechanism, again as described above. On the exterior of the housing 330 where the axle attaches to the handle 352 is an IP 67 rated stainless steel bearing 354. Within the housing, the axle is attached to an internal pillow block bearing 348. Between the pillow block bearing 348 and the exterior wall of the housing 320 is an electrical contact slip ring 350 for communicating power to the sensor line and/or signal data from the sensor line.

The output of the slip ring 350 connects to an IP 67 rated electrical connector 340 that allows connection to the sensor line from outside of the sealed spool housing 330. In the typical installation these electrical and signal connections would be conveyed directly into the electronics enclosure 332 without the need for external cabling or conductors. The axle may preferably be hollow in order to allow the flexible sensor spool end to be attached to the input of the slip ring 350. The spool housing 330 is completely sealed except for one opening on the lower panel that allows the sensor line 346 to pass through into the tank 324 through the tank collar 322. This opening will typically be a stainless steel tube that is fit with an IP 67 rated stainless steel seal bearing 328. The bearing may be fitted into the appropriate sized tank adaptor 326. Once the tank adaptor 326 is screwed into the tank 324 and properly tightened, the system is completely sealed so as to allow no gases or other materials to escape. The purpose of the stainless steel bearing 328 and tank adaptor 326 is to allow rotational positioning of the sensor housing to fit the needs of installation. Once the housing is in place, another indexed spring loaded latch (not shown) will lock the complete housing so that it can not spin freely.

FIG. 9A is a partially schematic side view of the spooled sensor system showing an alternate arrangement of the spool enclosure 330 and the electronics enclosure 332 of the system 320. The various bearings and seals described above are disclosed. FIG. 9B is a partial cross-sectional view of the spool system shown in FIG. 9A within the enclosures 330 and 332, disclosing the manner in which the axle of the spool 338 conducts whatever power or signal line requirements there are with the sensor line 346 through the appropriate slip ring 350 and bearings 354 & 348 to the electronics enclosure 332. The components within electronics enclosure 332 include, as described above, circuit board 344, power in connector 334, and communications antenna 336.

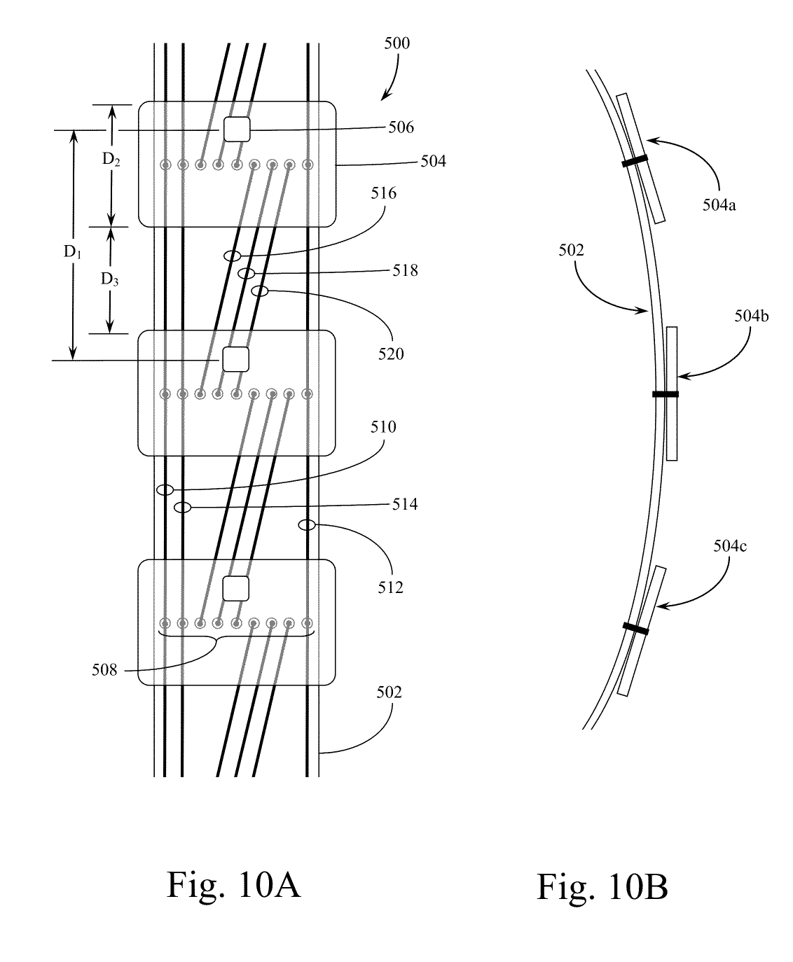

Reference is next made to FIGS. 10A & 10B for additional detail regarding the sensor embodiment shown generally in FIG. 1C. In this embodiment, the flexible printed circuit board is replaced by multiple rigid printed circuit board (PCB) sections 504 each with a discrete magnetically sensitive sensor element 506. These rigid PCB sections 504 are interconnected with flexible conductor paths 508, again either as discrete wires or short lengths of printed conductive pathways. The detail shown in FIG. 10A discloses the configuration of the rigid PCB sections 504, as well as the placement of the sensor elements 506 and the conductor paths or wires interconnecting the various rigid PCB sections 504.

In the preferred embodiment, the sensor elements 506 are approximately 0.5″ in height (distance D₂) spaced 0.5″ apart (distance D₃) so as to provide 1″ intervals (distance D₁) between each of the sensor elements, according to their placement on the rigid PCB sections 504 and the placement of the rigid PCB sections 504 on the flexible conductor component 502. As shown in the embodiment in FIG. 10A, connections between the discrete rigid PCB sections 504 can be made utilizing as few as nine connections on each PCB section. As shown, a ground path 512 and a power path 510 are present across each of the sections as is a home conductor path 514. Daisy chain connections are made between each rigid PCB section 504 that provide clock 516, data 518, and CE (carrier envelope) signal 520. The above described geometry and arrangement for the sensor chain allows for curved flexibility in at least one direction suitable for coiling the sensor on a spool as is essential to the structure and operation of the present invention.

FIG. 10B is a side view of a portion of the sensor line and shows the manner in which the individual rigid PCB sections 504a-504c may be attached at a single point (along the row of electrical conductor connections) in a manner that allows the sensor string to maintain its overall flexibility while reducing the cost of manufacturing the sensor string as a whole. Individual rigid PCB sections 504 may be manufactured and placed on the less expensive flexible conductor 502 in a manner that greatly reduces the cost of manufacture and still retains the accuracy required with precise spacing of the sensor elements.

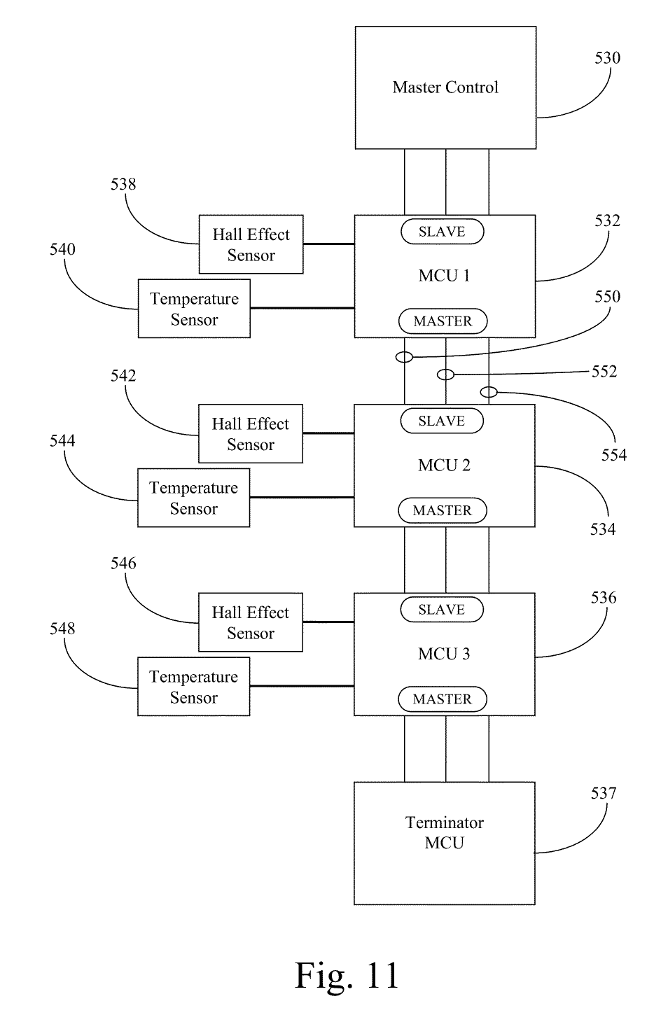

Reference is next made to FIG. 11 which provides an electronic schematic block diagram showing the various components associated with the sensor elements placed on the rigid PCB sections shown generally in FIG. 10A. FIG. 11 provides the components associated with a representative section of the flexible sensor string that is repeated indefinitely between the master microcontroller unit and a terminator microcontroller unit. In the example or section of sensor string shown in FIG. 11, three microcontroller units (MCU) are positioned in a chain between a master serving as the top end of the chain and a terminator serving as the tail end of the chain. Each individual microcontroller unit (MCU) serves as slave to the unit above it and as master to the unit below it. Each MCU is connected to its own temperature sensor and magnetic sensor (a Hall Effect sensor in the embodiment described).

The daisy chain operation proceeds as follows. Power is applied and the master unit 530 asserts WAKE signal line 550 to MCU1 532. MCU1 532 takes a reading from the Hall Effect sensor 538 and the temperature sensor 540. The master microcontroller 530 reads four bytes of data 554 from MCU1 532 and determines if checksums match. If so, the master 530 stores this value as SENSOR 1 data.

In turn, MCU1 532 asserts a WAKE signal line 550 to MCU2 534. MCU2 534 takes a reading from its Hall Effect sensor 542 and temperature sensor 544. MCU1 532 reads four bytes of data 554 from MCU2 534. If checksums match, MCU1 532 stores this value. MCU1 532 now stores four bytes of data from MCU2 534 and on the next read from MCU1 532 by the master 530, will not read the Hall Effect sensor 538 or the temperature sensor 540, but instead MCU1 532 will send the value from MCU2 534.

This process is repeated between MCU2 534 and MCU3 536. MCU2 534 asserts a WAKE signal line 550 to MCU3 536. MCU3 536 takes a reading from its Hall Effect sensor 546 and temperature sensor 548. MCU2 534 reads four bytes of data 554 from MCU3 536 and, if checksums match, MCU2 534 stores this value. MCU2 534 now stores four bytes of data 554 from MCU3 536 and on the next read from MCU1 532 will not read its Hall Effect sensor 542 or its temperature sensor 544, but instead MCU2 534 will send the value from MCU3 536.

The values therefore walk up the chain on subsequent reads by the master microcontroller unit 530. The last module in the chain, referred to as the terminator MCU 537, sends a pre-defined value instead of readings from a Hall Effect sensor or temperature sensor. When the master controller 430 sees this value, it recognizes that the end of the chain has been reached.

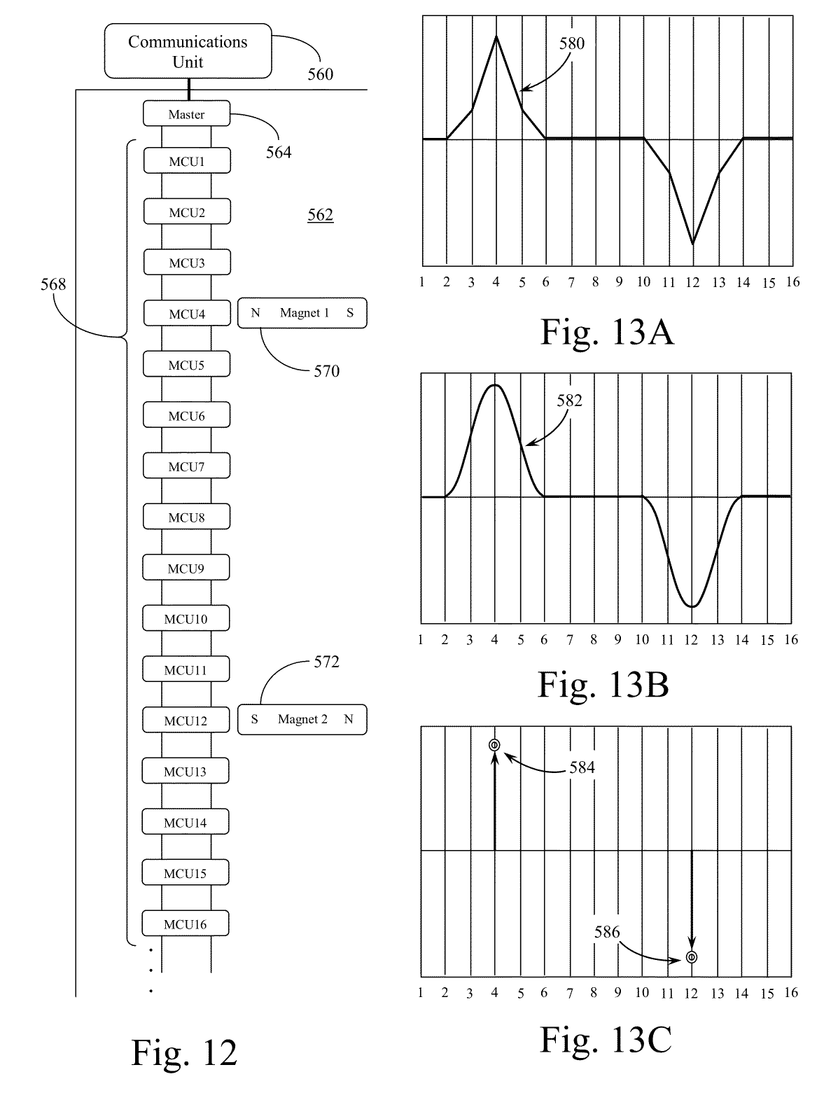

Reference is next made to FIG. 12 which provides an overview of the sensor operation within a tank 562 in conjunction with the floating magnet elements 570 & 572 proximal to the various microcontroller units 568 containing the Hall Effect sensors. The polarity of the respective magnets 570 & 572 are opposite so as to provide a distinguishing signature (reflected in the data plots described below). The communications unit 560 wakes up from a sleep cycle and applies power to the daisy chain strand. Master microcontroller 564 reads values from MCU1 (and so on) by way of the method described above. This is repeated until all sensors from the daisy chain are read (i.e. the terminator MCU is identified).

The data received is fit to curves and a position is determined based upon a curve fitting approach as shown in FIGS. 13A-13C. The discrete sensor readings are plotted 580 on the graph shown in FIG. 13A with a curved fitting function 582 disclosed on the graph of FIG. 13B. The curve fitting algorithm results in discrete position information 584 & 586 that identifies, in this example, Magnet 1 positioned at the 4″ level with Magnet 2 positioned at the 12″ level. As discussed above, this provides accurate level measurements for two different fluids (such as water and oil) contained within the tank.

In the manner of operation described above, the sensor system is capable of operating with low power requirements based upon its process of cascading power down to only that sensor being measured. In other words, the individual MCU devices are not all powered simultaneously in order for the daisy chain operation to be carried out. Power is required and drawn only by the MCU that is providing the signal information at a given point in time.

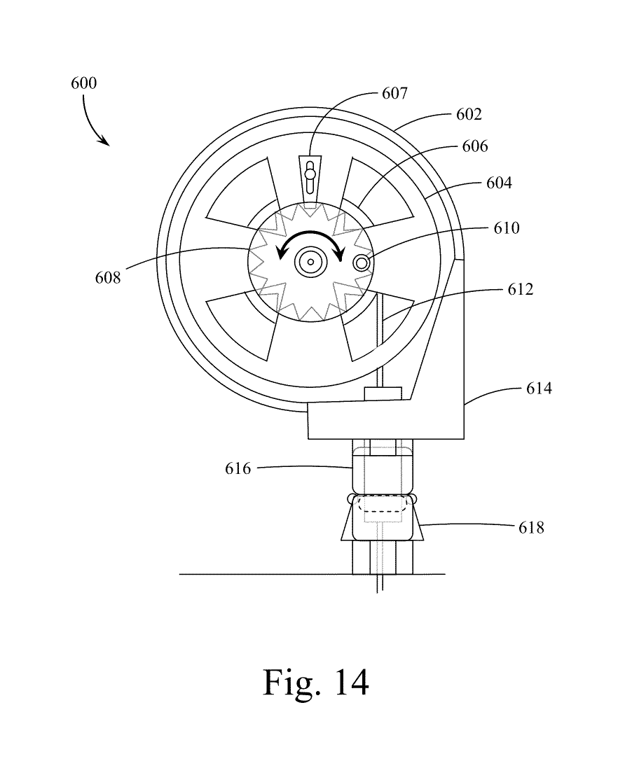

Reference is finally made to FIG. 14 for a description of a further alternate implementation of the system of the present invention in conjunction with a flexible sensor element comprising magnetically sensitive sensor elements, such as Hall Effect sensors or reed switches. Sensor system 600 generally includes spark proof or explosion proof enclosure 602 having an enclosure base 614 connected to and open through cam and groove fittings 616 & 618. This spool side of the enclosure 602, shown open for clarity, is in flow communication with, and where applicable, maintains a seal with the tank environment. The electronics of the system in this embodiment are not shown but are understood to be contained within a separate enclosure positioned next to the spool enclosure 602. Signal connections between the two enclosures are as described above.

Within spool enclosure 602 is positioned spool 604, operable by external hand crank 610 in this embodiment. Ratcheting latch 607 allows the spool to be fixed in a rotated position after deployment of the flexible sensor element 612, depending on the specific application. A quantity of flexible sensor 606 is reeled onto spool 604 in the manner shown. The end of flexible sensor 612 may be drawn out from spool 604 in the deployment process. Tank collar coupling 616 & 618 incorporate a location magnet as described above to provide a manner of referencing the deployment and position of the sensor system within the tank.

In general, the operation of the system shown in FIG. 14 involves positioning and placement of the enclosure onto the tank collar with the end of the spooled flexible sensor line directed through the tank collar into the tank. Once fixed to the tank collar with a sealed connection, the user rotates the external handle which turns the spool of sensor line and deploys the end of the sensor element into the tank according to the length required by the specific tank size and configuration. A locking latch system described above then fixes the spool at the desired deployment length for operation of the sensor system.

Although the present invention has been described in conjunction with a number of preferred embodiments, those skilled in the art will recognize that alternate embodiments of the sensor line itself may be likewise structured onto the spooled deployment configuration defined and described herein. A number of sensor methodologies lend themselves not only to flexible sensor lines, but also to the spooling configuration of the system of the present invention. Specific details regarding the manner in which the sensor systems operate according to known techniques such as TDR measurements and other known methodologies, can be implemented in conjunction with the spooled flexible sensor structures of the present invention.

Implementation of the system of the present invention finds its best application in conjunction with a unique, low power, daisy chain sensor array interrogation process. Eliminating the need to simultaneously power and interrogate a large linear array of sensors, the methods of the present invention provide a solution to the problems associated with remote monitoring of a tank positioned at some distance from utility power lines. Those skilled in the art will recognize, however, that the systems and methods described herein find beneficial applicability in environments where such utility based power is readily available. Overall, the system and method of the present invention provide as close to a “plug and play” tank level measurement device as possible, providing both versatility and accuracy, especially in remote locations.

I claim:

1. A liquid level measurement device for installation on a tank holding one or more liquids, the device comprising:
a length of flexible sensor line, the flexible sensor line comprising a linear array of sensor elements;
a rotatable spool holding a wound portion of the length of flexible sensor line;
a spool enclosure surrounding the rotatable spool and the wound portion of the length of flexible sensor line;
a conduit extending from the spool enclosure into the tank, the conduit surrounding an extended portion of the length of flexible sensor line; and
signal instrumentation for interrogating a plurality of sensors in the linear array of sensor elements.
